(19) United States
(12) Patent Application Publication
(10) Pub. No.: US 2011/0280442 A1
(43) Pub. Date: Nov. 17, 2011

(54) OBJECT MONITORING SYSTEM AND METHOD

(75) Inventors: CHIEN-LIN CHEN, Tu-Cheng (TW); CHIH-CHENG YANG, Tu-Cheng (TW)

(73) Assignee: HON HAI PRECISION INDUSTRY CO., LTD., Tu-Cheng (TW)

(21) Appl. No.: 12/914,968

(22) Filed: Oct. 28, 2010

(30) Foreign Application Priority Data
May 13, 2010 (TW) 99115231

(51) Int. Cl. G06K 9/00

(52) U.S. Cl. 382/103

(57) ABSTRACT

An object monitoring system and method identify a foreground object from a current frame of a video stream of a monitored area. The object monitoring system determines whether an object has entered or exited the monitored area according to the foreground object, and generates a security alarm. The object monitoring system searches N pieces of reference images just before an image is captured at the time of a generation of the security alarm, and detects information related to the object from the N pieces of reference images. By comparing the related information with vector descriptions of human body models stored in a feature database, and a holder or a remover of the object can be recognized.

This application is related to copending U.S. patent application entitled “Object monitoring system and method” filed on Oct. 11, 2010 and accorded Ser. No. 12/901,582.

### BACKGROUND

1. Technical Field

Embodiments of the present disclosure generally relate to image processing, and more particularly to an object monitoring system and method.

2. Description of Related Art

Object tracking methods are well known and popularly used in monitoring systems. However, it is difficult to monitor changes of an object in a monitored area when the object enters or exits the monitored area, because moving backgrounds (i.e., movement of leaves on a plant), shadows, highlights, and illumination are usually changed.

### BRIEF DESCRIPTION OF THE DRAWINGS

FIG. 1 is a system view of one embodiment of an electronic device comprising an object monitoring system.

FIG. 2 is a block diagram of one embodiment of the electronic device in FIG. 1.

FIG. 3 is a block diagram of one embodiment of a foreground detection unit in FIG. 2.

FIG. 4 is a flowchart illustrating one embodiment of a foreground object monitoring method.

FIG. 5 is a detailed description of block S400 in FIG. 4.

FIG. 6 is an example illustrating detected foreground objects.

FIG. 7 is a schematic diagram illustrating the relationship between the background model and the temporary background model.

FIG. 8 is a detailed description of block S402 in FIG. 4.

FIG. 9 is an example illustration featuring extraction and image cutting of an object entering into a monitored area.

FIG. 10 is an example illustrating a method of identifying a pixel in close proximity to a foreground pixel as an interest pixel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a set of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

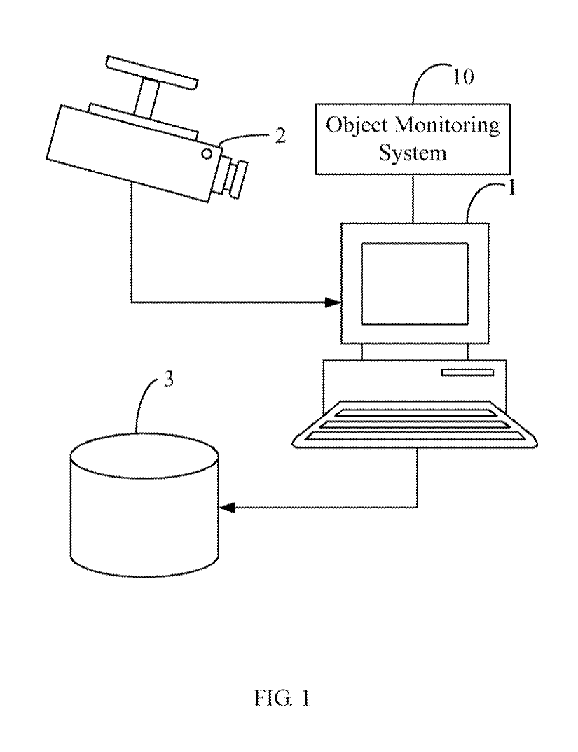

FIG. 1 is a system view of one embodiment of an electronic device 1 comprising an object monitoring system 10. The electronic device 1 connects to a monitoring device 2 and a feature database 3. The object monitoring system 10 can determine whether an object (e.g., a box, a car, etc) enters or exits an area (hereinafter referred as “the monitored area”) by detecting a digital video stream captured by the monitoring device 2, generate a security alarm accordingly, and recognize a holder or a remover of the object. In one embodiment, the holder is a person taking the object into the area, and the remover is a person carrying the object out of the area. In the embodiment, the video stream includes at least one video frame generated by the monitoring device 2, and is used for monitoring the monitored area. The feature database 3 stores a number of descriptions of vectors (hereinafter referred as “vector descriptions”) of object models, namely stores a number of vector space models. In the embodiment, the object models may be human body models, for example.

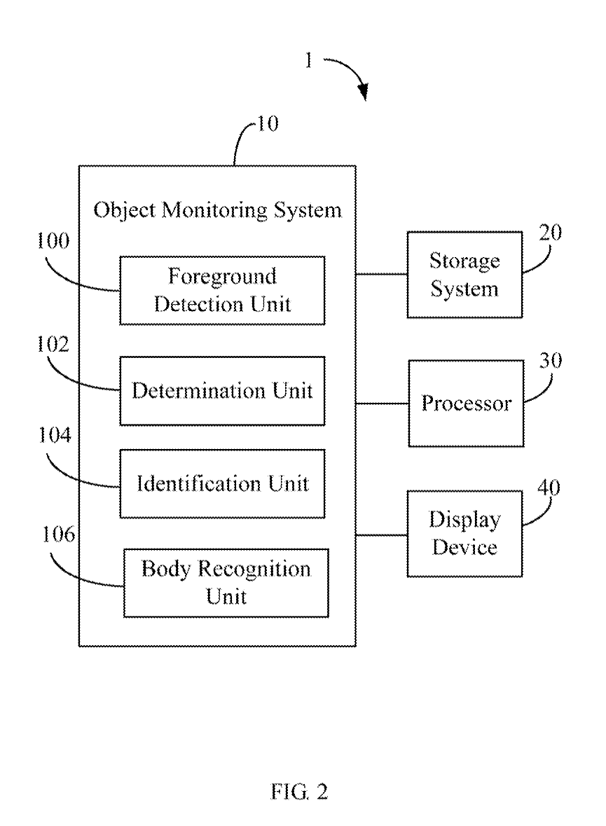

As illustrated in FIG. 2, the electronic device 1 further includes a storage system 20, at least one processor 30, and a display device 40. In one embodiment, the monitoring system 10 includes a foreground detection unit 100, a determination unit 102, an identification unit 104, and a body recognition unit 106. Each of the units 100-106 may be a software program including one or more computerized instructions that are stored in the storage system 20 and executed by the processor 30. The display device 40 is operable to display the video stream.

In one embodiment, the storage system 20 may be a magnetic or an optical storage system, such as a hard disk drive, an optical drive, or a tape drive. The storage system 20 also stores the video stream of the monitored area captured by the monitoring device 1. The display device 40 may be a display screen, such as a liquid crystal display (LCD) or a cathode-ray tube (CRT) display.

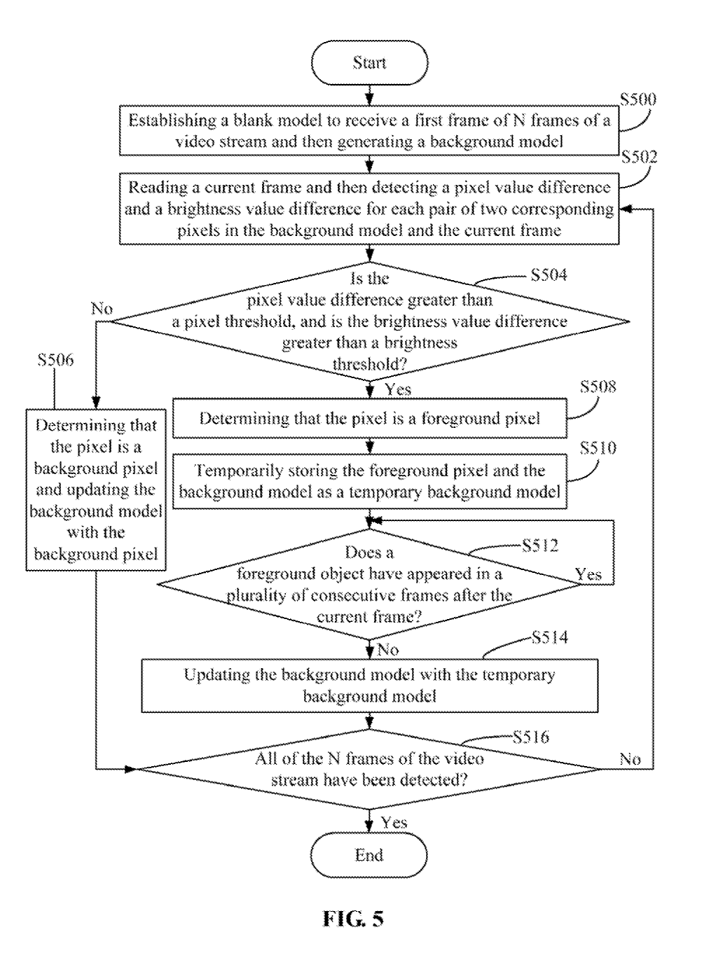

The foreground detection unit 100 identifies a foreground object from a current frame of the video stream using at least two models. In some embodiments, the at least two models include a background model and a temporary background model. A detailed description of the foreground detection unit 100 is illustrated in FIG. 5 as below.

In some embodiments, if the foreground object has appeared in more than one frame after the current frame, the determination unit 102 saves foreground pixels of the foreground object in the temporary background model. The determination unit 102 also marks foreground pixels of the foreground object as interest points.

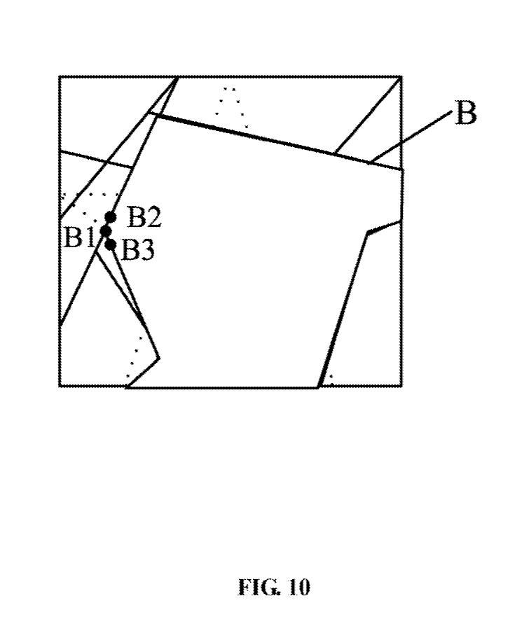

The determination unit 102 further determines whether value differences between the foreground pixels and a plurality of corresponding pixels are less than a predetermined threshold. In some embodiments, the plurality of corresponding pixels are pixels in close proximity. If the value differences between the foreground pixels and the corresponding pixels are less than the predetermined threshold, the determination unit 102 identifies the corresponding pixels as the interest points. For example, as illustrated in FIG. 10, the point B1 is the foreground pixel, the points B2 and B3, which correspond to pixels of the foreground pixel B1, are identified as two interest points. All interest points determined by the foreground object form a first pixel set.

The determination unit 102 searches a plurality of pixels from the background model corresponding to the first pixel set if a pixel number of the first pixel set is larger than a determined value. All searched pixels in the background model form a second pixel set. It is understood that the predetermined threshold, and the determined value may be adjusted according to user's requirements.

The determination unit 102 further extracts feature points from each of the two pixel sets and obtains a vector description of each of the feature points using a feature extraction algorithm. The feature points are used for feature detection. The feature points may be isolated points, or successive points forming continuous curves or connected regions. In one embodiment, the feature extraction algorithm may be a scale-invariant feature transform (SIFT) algorithm, or speeded up robust features (SURF) algorithm, for example.

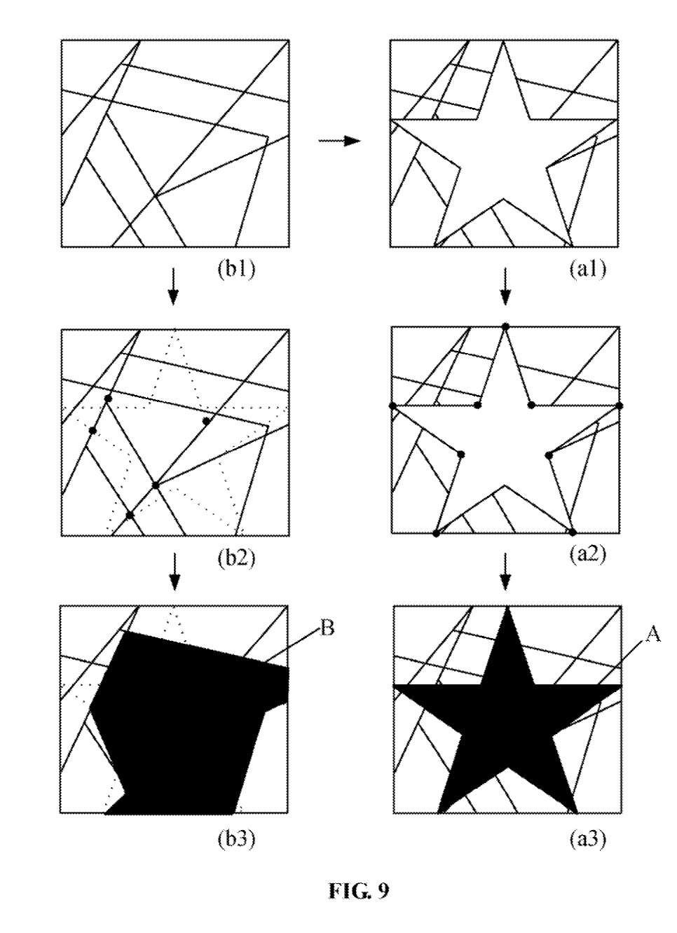

As shown in FIG. 9, the pictures (b1) and (a1) are examples illustrating the temporary background model and the background model, respectively. In picture (b2), small black points illustrating an outline of a dashed star are the interest points in the first pixel set. Five big black dots in the picture (b2) are the feature points extracted from the first pixel set. Black dots in the picture (a2) are the feature points extracted from the second pixel set.

The determination unit 102 defines each of the feature points as a seed, and executes a seed filling algorithm on each of the two pixel sets according to all seeds. The determination unit 102 cuts the seed filled images, and obtains two areas, such as a first area B and a second area A shown in pictures (b3) and (a3) of FIG. 9.

The identification unit 104 identifies whether an object has entered or exited the monitored area by comparing the size of the first area B and that of the second area A. If the size of the first area B is larger than that of the second area A, the identification unit 104 determines that the object has exited the monitored. For example, a person carrying a box has exited the monitored area. If the size of the first area B is less than that of the first area A, the identification unit 104 determines that the object has entered the monitored area. For example, a car enters the monitored area. If the size of the first area B is equal to that of the second area A, the identification unit 104 determines that no object has entered or exited the monitored area.

In the embodiment, the identification unit 104 further detects whether the object has exited within a determined time period. Upon the condition that the object has exited within the determined time period, the identification unit 104 generates a security alarm to alert a security guard. Upon detecting that the object has entered the monitored area, the identification unit 104 determines whether the object meets a size identification, a color identification and an entry time identification. The identification unit 104 compares the vector description of each of the feature points of the object with a corresponding vector description stored in the feature database 3 to identify the object. The identification unit 104 further generates the security alarm to immediately alert the security guard.

The body recognition unit 106 extracts feature points of the object, obtains a vector description of each of the feature points, and searches N pieces of reference images previous to an image captured at the time of a generation of the security alarm. In the embodiment, the N pieces of reference images are consecutive images. The body recognition unit 106 further detects information related to the object from the N pieces of previous images, records the related information in the storage system 20, and recognizes a holder or a remover of the object by comparing the related information with the vector descriptions of the human body models stored in the feature database 3.

In detail, if the identification unit 104 identifies the object has entered the monitored area, the body recognition unit 106 recognizes a holder of the object, for example, the body recognition unit 106 recognizes a person who carries a box to enter the monitored area. If the identification unit 104 identifies the object has exited the monitored area, the body recognition unit 106 recognizes a remover of the object, for example, the body recognition unit 106 recognizes a person who carries a box to exit the monitored area.

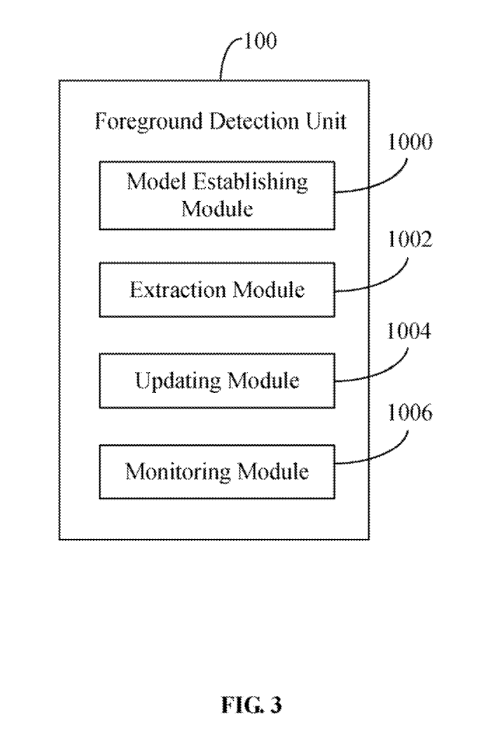

FIG. 3 is a block diagram of one embodiment of the foreground detection unit 100. In one embodiment, the foreground detection unit 100 includes a model establishing module 1000, an extraction module 1002, an updating module 1004, and a monitoring module 1006. Each of the modules 1000-1006 may be a software program including one or more computerized instructions that are executed by the processor 30.

The model establishing module 1000 establishes a blank model to receive a first frame of N frames of the video stream, and then generates a background model. In the embodiment, the blank model is a blank frame.

The extraction module 1002 reads a current frame of the video stream and then detects a pixel value difference and a brightness value difference for each pair of two corresponding pixels in the background model and the current frame for each of the N frames of the video stream.

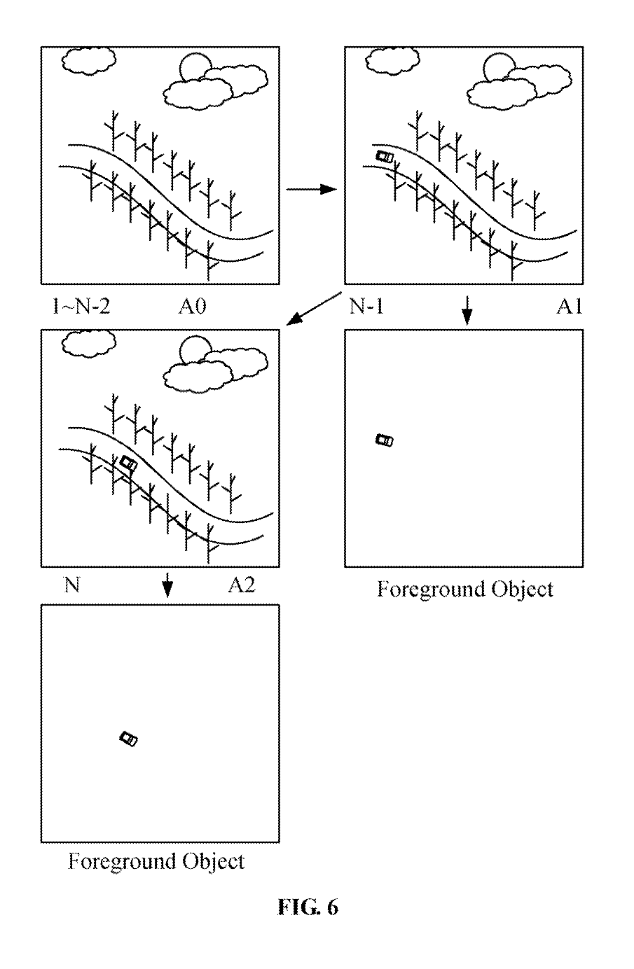

In some embodiments, if both of the pixel value difference and the brightness value difference are less than or equal to a pixel threshold and a brightness threshold, respectively, the pixel in the current frame is determined as a background pixel. It is understood that values of the pixel threshold and the brightness threshold may be adjusted. For the background pixel in the current frame, the updating module 1004 updates the background model by adding the background pixel to the background model. In one example, as illustrated in FIG. 6, the background model (denoted as “A0”) is established by frames 1 to frames (N−2). After background pixels are detected in the frame (N−1), the background model A0 is updated to be background model A1. For detecting the foreground object of the frame N, the extracting module 1002 detects a pixel value difference and a brightness value difference for each pair of two corresponding pixels in the background model A1 and the frame N.

If any one or two of the pixel value difference and the brightness value difference are greater than the pixel threshold and the brightness threshold, respectively, the pixel in the current frame is determined as a foreground pixel.

It is understood that the extraction module 1002 continuously reads each of the N frames of the video stream, and detects the foreground object in each frame of the video stream by detecting the pixel value difference and the brightness value difference for each pair of two corresponding pixels of two consecutive frames after the current frame as mentioned above. The foreground object is defined by one or more foreground pixels.

For example, after the current frame, the extraction module 1002 reads a next current frame and detects a pixel value difference and a brightness value difference for each pair of two corresponding pixels in the background model and the next current frame. In one example, as illustrated in FIG. 6, the background model (denoted as “A1”) is a background model established by frames 1 to frames (N−1). After detecting a pixel value difference and a brightness value difference for each pair of two corresponding pixels in the background model A1 and the frame N, the background model A1 is updated to be background model A2. In addition, the foreground object (i.e., a car) is also identified.

Upon determining at least one foreground pixel in the current frame, foreground pixels in the current frame located in close proximity are determined as one foreground object. For example, the extracting model 1002 reads the frame N and determines the car, as shown in background model A2 in FIG. 6, as the foreground object. It is understood that one frame may have one or more foreground objects.

In response to a determination of the foreground object in each frame of the video stream, the updating module 1004 temporarily stores the foreground object and the background model as a temporary background model. The monitoring module 1006 detects if the foreground object have appeared in a plurality of consecutive frames after the current frame. If the foreground object has appeared in a plurality of consecutive frames after the current frame, the updating module 1004 updates the background model with the temporary background model. In some embodiments, the time period may be adjusted.

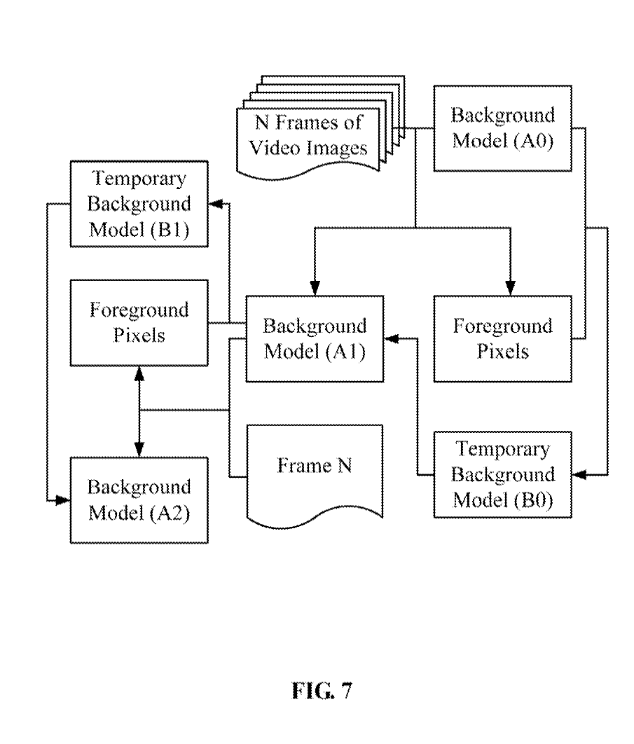

As shown in FIG. 7, if the foreground object has not appeared in a plurality of consecutive frames after the current frame, the monitoring module 1006 keeps monitoring the temporary background model.

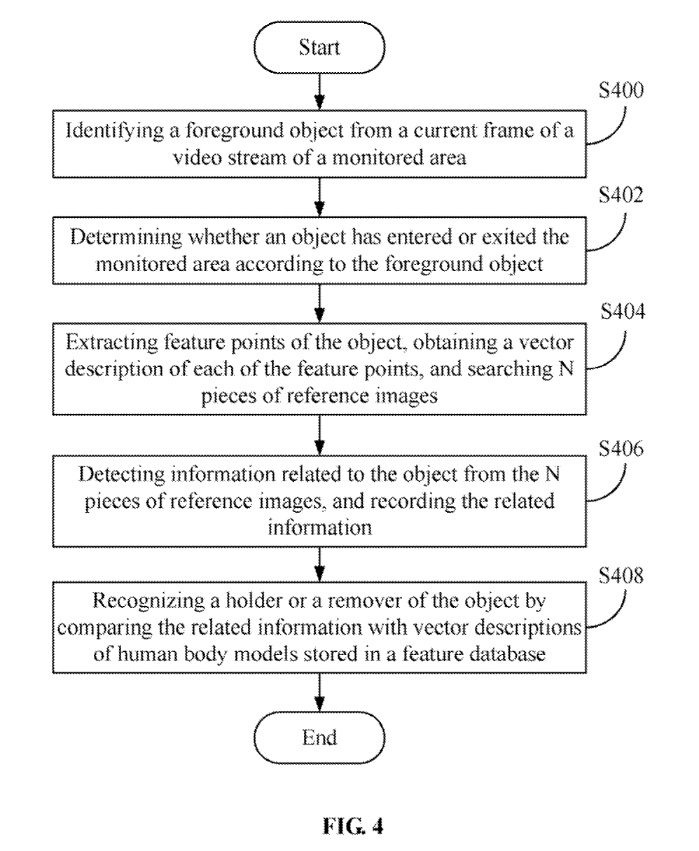

FIG. 4 is a flowchart illustrating one embodiment of a foreground object monitoring method. Depending on the embodiment, additional blocks may be added, others removed, and the ordering of the blocks may be changed.

In block S400, the foreground detection unit 100 uses at least two models to identify a foreground object from a current frame of a video stream generated by the monitoring device. In one embodiment, the at least two models are stored in the feature database 3, and include a background model and a temporary background model. Details of the foreground object detection method are descried in FIG. 5.

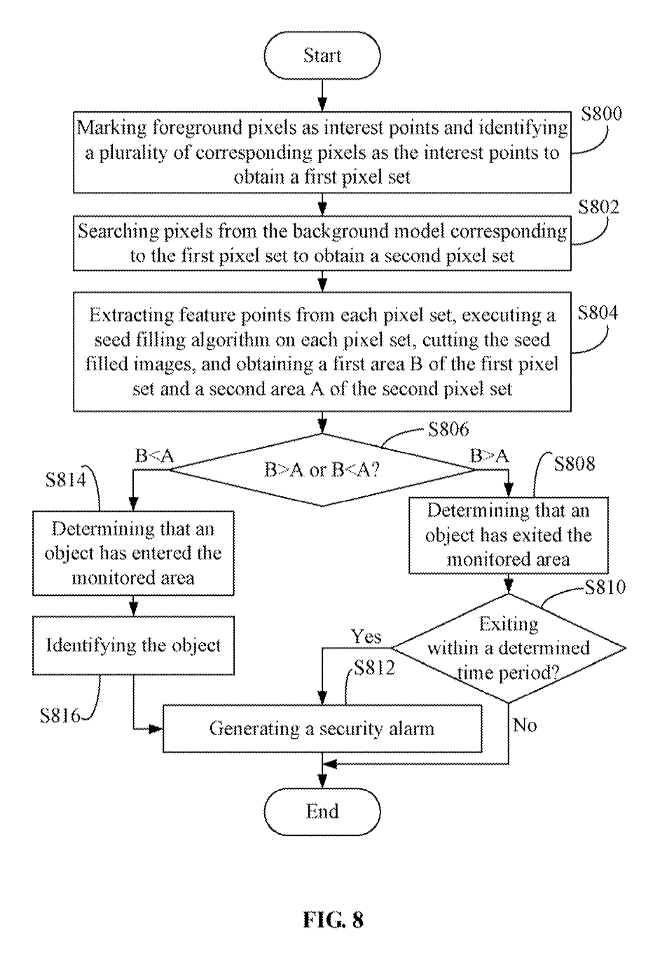

In block S402, the determination unit 102 and the identification unit 104 determines whether an object has entered or exited the monitored area according to the detected foreground object and the at least two models, and generates a safety alarm if the object has entered or exited the monitored area. Details of determining whether the object has entered or exited the monitored area are described in FIG. 8.

In block S404, the body recognition unit 106 extracts feature points of the object, obtaining a vector description of each of the feature points, and searches N pieces of reference images previous to an image captured at the time of a generation of the security alarm.

In block S406, the body recognition unit 106 detects information related to the object from the N pieces of previous images, and records the related information in the storage system 20.

In block S408, the body recognition unit 106 recognizes a holder or a remover of the object by comparing the related information with the vector descriptions of the human body models stored in the feature database 3.

FIG. 5 is a flowchart illustrating one embodiment of a foreground object monitoring method using the foreground detection unit 100 of FIG. 2. Depending on the embodiment, additional blocks may be added, others removed, and the ordering of the blocks may be changed.

In block S500, the model establishing module 1000 establishes a blank model to receive a first frame of N frames of the video stream, and then generates a background model. In the embodiment, the blank model is a blank frame.

In block S502, the extraction module 1002 reads a current frame (i.e., a second frame of the N frames of the video stream) of the video stream and then detects a pixel value difference and a brightness value difference for each pair of two corresponding pixels in the background model and the current frame.

In block S504, the extraction module 1002 determines whether the pixel value difference and the brightness value difference are greater than a pixel threshold and a brightness threshold, respectively. If both of the pixel value difference and the brightness value difference are less than or equal to a pixel threshold and a brightness threshold, respectively, the flow goes to block S508. If any one or two of the pixel value difference and the brightness value difference are greater than the pixel threshold and the brightness threshold, respectively, the flow goes to block S506.

In block S508, the extraction module 1002 determines that the pixel in the current frame is a background pixel. The updating module 1004 updates the background model with the background pixel, and the flow goes to block S516.

In block S506, the extraction module 1002 determines that the pixel in the current frame is a foreground pixel. Upon determining at least one foreground pixel in the current frame, foreground pixels in the current frame located in close proximity are determined as one foreground object in the current frame. It is understood that one frame may have one or more than one foreground objects.

In block S510, the updating module 1004 temporarily stores the foreground pixel and the background model as a temporary background model.

In block S512, the monitoring module 1006 monitors the temporary background model, and determines if the foreground object has appeared in a plurality of consecutive frames after the current frame.

If the foreground object has appeared in a plurality of consecutive frames after the current frame, in block S514, the updating module 1004 updates the background model with the temporary background model.

If the foreground object has not appeared in a plurality of consecutive frames after the current frame, in block S512, the monitoring module 1006 keeps monitoring the temporary background model.

In block S516, the extraction module 1002 determines whether all of the N frames of the video stream have been detected. If any one of the N frames has not been detected, the flow returns to block S502. The extraction module 1002 reads a next current frame and detects a pixel value difference and a brightness value difference for each pair of two corresponding pixels in the background model and the next current frame for each of the N frames of the video stream. If all of the N frames of the video stream have been detected, the flow ends.

FIG. 8 is a flowchart illustrating one embodiment of a foreground object monitoring method. Depending on the embodiment, additional blocks may be added, others removed, and the ordering of the blocks may be changed.

When the foreground object has appeared in more than one frame after the current frame, in block S800, the determination unit 102 saves foreground pixels of the foreground object in the temporary background model, and then marks foreground pixels of the foreground object as interest points. The determination unit 102 determines whether value differences between the foreground pixels and a plurality of corresponding pixels are less than a predetermined threshold. In some embodiments, the plurality of corresponding pixels are pixels in close proximity. If the value differences between the foreground pixels and the corresponding pixels are less than the predetermined threshold, the determination unit 102 identifies the corresponding pixels as the interest pixels. All interest pixels form a first pixel set.

Upon the condition that a pixel number of the first pixel set is larger than a determined value, in block S802, the determination unit 102 searches a plurality of pixels from the background model corresponding to the first pixel set. All searched pixels in the background model form a second pixel set.

In block S804, the determination unit 102 extracts feature points from each of the two pixel sets and obtains a vector description of each of the feature points using a feature extraction algorithm. The determination unit 102 defines each of the feature points as a seed, and executes a seed filling algorithm on each of the two pixel sets. After cutting the seed filled images of the two pixel sets, the determination unit 102 obtains a first area B of the first pixel set and a second area A of the second pixel set. The identification unit 104 calculates a size of the first area B, and a size of the second area A.

In block S806, the identification unit 104 identifies whether an object has entered or exited the monitored area by comparing the size of the first area B with that of the second area A. If the size of the first area B is larger than that of the second area A, the flow goes to block S808. If the size of the first area B is less than that of the second area A, the flow goes to block S814.

In block S808, the identification unit 104 determines that the object has exited the monitored area, and in block S810, the identifying unit 104 detects whether the object has exited within a determined time period. If the object has exited within the determined time period, the flow goes block S812. If the object has not exited within the determined time period, the flow ends.

In block S812, the identification unit 104 generates a security alarm to alert a security guard in the vicinity of the object.

In block S814, the identification unit 104 determines that the object has entered the monitored area.

In block S816, the identification unit 104 determines whether the object meets a size identification, a color identification and an entry time identification. After the identification unit 104 compares the vector description of each of the feature points of the object with a corresponding vector description stored in the feature database 3, the object can be identified, and then the flow goes to block S812.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An object monitoring method, the method comprising:
identifying a foreground object from a current frame of a video stream of a monitored area using at least two models stored in a feature database, the at least two models comprising a background model and a temporary background model;
determining whether an object has entered or exited the monitored area according to the foreground object and the at least two models, and generating an alarm upon the condition that the object has entered or exited the monitored area;
searching N pieces of reference images previous to an image captured at the time of the generation of the security alarm;
detecting information related to the object from the N pieces of reference images; and
recognizing a holder or a remover of the object by comparing the related information with vector descriptions of human body models stored in the feature database.

2. The method as described in claim 1, wherein the determining block comprises:
marking foreground pixels of the foreground object as interest points upon the condition that the foreground object has appeared in more than one frame after the current frame;
identifying a plurality of corresponding pixels as the interest points to obtain a first pixel set upon the condition that value differences between the foreground pixels and the corresponding pixels are less than a predetermined threshold;
searching pixels corresponding to the first pixel set from the background model to obtain a second pixel set, upon the condition that a pixel number of the first pixel set is larger than a determined value; and
determining whether an object has entered or exited the monitored area by comparing a size of the first pixel set with a size of the second pixel set.

3. The method as described in claim 2, before the determining block further comprising:
extracting feature points from the first pixel set and the second pixel set, and obtaining a vector description of each of the feature points using a feature extraction algorithm;
defining each of the feature points as a seed;
executing a seed filling algorithm on the first pixel set and the second pixel set and obtaining seed filled images of the two pixel sets;
cutting the seed filled images; and
obtaining a first area of the first pixel set and a second area of the second pixel set.

4. The method as described in claim 3, further comprising:
determining that the object has exited the monitored area, upon the condition that the size of the first area is larger than that of the second area; or
determining that an object has entered the monitored area, upon the condition that the size of the first area is less than that of the second area.

5. The method as described in claim 4, further comprising:
detecting whether the object has exited within a determined time period upon the condition that the object has exited the monitored area; and
generating an alarm upon the condition that the object has exited within the determined time period.

6. The method as described in claim 4, further comprising:
determining whether the object meets a size identification, a color identification and an entry time identification upon the condition that the object has entered the monitored area; and
identifying the object by comparing the vector description of each of the feature points of the object with a corresponding vector description stored in a feature database.

7. The method as described in claim 1, before the searching block comprises:
extracting feature points of the object and obtaining a vector description of each of the feature points.

8. An electronic device for object detection, the electronic device comprising:
at least one processor;
a storage system; and
an object monitoring system stored in the storage system and executed by the at least one processor, the object monitoring system comprising:
a foreground detection unit operable to identify a foreground object from a current frame of a video stream of a monitored area using at least two models, the at least two models comprising a background model and a temporary background model;
an identification unit operable to determine whether an object has entered or exited the monitored area according to the foreground object and the at least two models, and generate an alarm upon the condition that the object has entered or exited the monitored area; and
a body recognition unit operable to search N pieces of reference images previous to an image captured at the time of a generation of the security alarm, detect information related to the object from the N pieces of reference images, and recognize a holder or a remover of the object by comparing the related information with vector descriptions of human body models stored in a feature database.

9. The electronic device as described in claim 8, further comprising a determination unit operable to:
mark foreground pixels of the foreground object as interest points, upon the condition that the foreground object has appeared in more than one frame after the current frame;
identify a plurality of corresponding pixels as the interest points to obtain a first pixel set upon the condition that value differences between the foreground pixels and the corresponding pixels are less than a predetermined threshold; and
search pixels corresponding to the first pixel set from the background model to obtain a second pixel set, upon the condition that a pixel number of the first pixel set is larger than a determined value.

10. The electronic device as described in claim 9, wherein the determination unit is further operable to extract feature points from the first pixel set and the second pixel set, obtain a vector description of each of the feature points using a feature extraction algorithm, define each of the feature points as a seed to execute a seed filling algorithm on the first pixel set and the second pixel set and obtain seed filled images of the two pixel sets, cut the seed filled images, and obtain a first area of the first pixel set and a second area of the second pixel set.

11. The electronic device as described in claim 10, wherein the identification unit is further operable to determine that the object has exited the monitored area upon the condition that a size of the first area is larger than a size of the second area, detect whether the object has exited within a determined time period, and generate a security alarm upon the condition that the object has exited within the determined time period.

12. The electronic device as described in claim 10, wherein the identification unit is further operable to determine that an object has entered the monitored area if a size of the first area is less than a size of the second area, determine whether the object meets a size identification, a color identification and an entry time identification, and identify the object by comparing the vector description of each of the feature points of the object with a corresponding vector description stored in a feature database.

13. The electronic device as described in claim 9, wherein the body recognition unit is further operable to extract feature points of the object and obtain a vector description of each of the feature points.

14. A non-transitory storage medium having stored thereon instructions that, when executed by a processor of an electronic device, cause the electronic device to perform an object monitoring method, the method comprising:
identifying a foreground object from a current frame of a video stream of a monitored area using at least two models stored in a feature database, the at least two models comprising a background model and a temporary background model;
determining whether an object has entered or exited the monitored area according to the foreground object and the at leas two models, and generating an alarm upon the condition that the object has entered or exited the monitored area;
searching N pieces of reference images previous to an image captured at the time of the generation of the security alarm;
detecting information related to the object from the N pieces of reference images; and
recognizing a holder or a remover of the object by comparing the related information with vector descriptions of human body models stored in the feature database.

15. The storage medium as described in claim 14, wherein the determining block comprises:
marking foreground pixels of the foreground object as interest points upon the condition that the foreground object has appeared in more than one frame after the current frame;
identifying a plurality of corresponding pixels as the interest points to obtain a first pixel set upon the condition that value differences between the foreground pixels and the corresponding pixels are less than a predetermined threshold;
searching pixels corresponding to the first pixel set from the background model to obtain a second pixel set, upon the condition that a pixel number of the first pixel set is larger than a determined value; and
determining whether an object has entered or exited the monitored area by comparing a size of the first pixel set with a size of the second pixel set.

16. The storage medium as described in claim 15, wherein the method further comprises blocks before the determining block:
extracting feature points from the first pixel set and the second pixel set, and obtaining a vector description of each of the feature points using a feature extraction algorithm;
defining each of the feature points as a seed;
executing a seed filling algorithm on the first pixel set and the second pixel set and obtaining seed filled images of the two pixel sets;
cutting the seed filled images; and
obtaining a first area of the first pixel set and a second area of the second pixel set.

17. The storage medium as described in claim 16, wherein the method further comprises:
determining that the object has exited the monitored area, upon the condition that the size of the first area is larger than that of the second area; or
determining that an object has entered the monitored area, upon the condition that the size of the first area is less than that of the second area.

18. The storage medium as described in claim 17, wherein the method further comprises:
detecting whether the object has exited within a determined time period upon the condition that the object has exited the monitored area;
generating a security alarm upon the condition that the object has exited within the determined time period.

19. The storage medium as described in claim 17, wherein the method further comprises:
determining whether the object meets a size identification, a color identification and an entry time identification upon the condition that the object has entered the monitored area; and
identifying the object by comparing the vector description of each of the feature points of the object with a corresponding vector description stored in a feature database.

20. The storage medium as described in claim 14, wherein the method further comprises a block before the searching block:
extracting feature points of the object and obtaining a vector description of each of the feature points.
